(19) United States
(12) Patent Application Publication
(10) Pub. No.: US 2022/0410230 A1
(43) Pub. Date: Dec. 29, 2022

(54) SYSTEM AND PROCESS FOR CLEANING HYDROCARBON STORAGE TANKS

(71) Applicant: OITECH S. DE R.L. DE C.V, Tabasco (MX)

(72) Inventors: Hussein KADOUR PONCE, Tabasco (MX); Victor Hugo RUIZ MONTIEL, Tabasco (MX); José Alejandro LLANOS PEREZ, Tabasco (MX)

(21) Appl. No.: 17/310,065

(22) PCT Filed: Jun. 3, 2020
(86) PCT No.: PCT/IB2020/055210

§ 371 Date: Jul. 14, 2021

(30) Foreign Application Priority Data
Nov. 26, 2019 (MX) MX/A/2019/014147

(51) Int. Cl. B08B 9/093

(52) U.S. Cl. CPC B08B 9/0936; B08B 9/0933; B08B 2209/08

(57) ABSTRACT

The present invention relates to a modular cleaning hydrocarbon storage tanks system, as well as a cleaning process which allows recovering crude oil from the waste sludge contained in the hydrocarbon storage tanks. Moreover, the present invention relates to the use of chemical mixtures applied during the hydrocarbon storage tanks cleaning process. The invention allows the recovery of crude oil from the waste sludge contained in said tanks.

### FIELD OF THE INVENTION

The present invention relates to a modular cleaning hydrocarbon storage tanks system, as well as a cleaning process which allows recovering crude oil from the waste sludge contained in the hydrocarbon storage tanks. Moreover, the present invention relates to the use of chemical mixtures applied during the hydrocarbon storage tanks cleaning process.

### BACKGROUND OF THE INVENTION

Different systems and compositions used for tank cleaning and the remaining sludge are known in the state of the art. For example, U.S. Pat. No. 7,594,996 discloses an oil recovery process, comprising the stages of a viscous petroleum product having contact with a water-based dispersion fluid, negatively charged forming a fluid suspension and having solid contaminants within; and processing the fluid suspension to separate and recover the petroleum product, the solid contaminants and the dispersion fluid as separate products; wherein said contact stage comprises injecting the dispersion fluid steps in contact with the petroleum product under relatively high pressure conditions to form the fluid suspension, conducting the fluid suspension through an injection chamber and injecting additional dispersion fluid establishing contact with the suspension into said injection chamber under relatively high pressure and shear conditions.

Similarly, U.S. Pat. No. 5,421,903 discloses A method for washing an oil tank and recovering and treating residual tank liquid, comprising the steps of:

loading on first conveyance means a first system unit equipped with a suction device for sucking and discharging residual liquid from a tank;

loading on second conveyance means a second system unit equipped with an oil-water separator for separating an oil component from residual liquid received from the first system unit, a device for treating the separated oil component and means for supplying washing liquid into the tank;

loading on a third conveyance means a third system unit equipped with an inert gas generator;

moving the first, second and third conveyance means to the tank to be washed;

interconnecting the first, second and third system units with the tank with piping;

operating the means for supplying washing liquid into the tank for jetting washing liquid into the tank;

operating the suction device for sucking and discharging the residual liquid from the tank;

operating the oil-water separator for separating an oil component from the discharged residual liquid;

operating the oil component treatment device for treating the separated oil component;

washing the tank with hot water; and

supplying inert gas into the tank during the aforesaid treatments.

On the other hand, US application 20060142172 discloses a composition for removing paraffin, heavy asphaltenes, oils, and other soils from oil wells and oil processing equipment comprising about 1 to 50% of a C10-C15 naphthalene depleted aromatic solvent blend containing less than 1% Naphthalene and less than 50 ppm toluene with a flash point about 100° and up to 10-50% of other additives.

Despite the existence of tank cleaning systems and tank cleaning compositions, no technology allows recovering a considerable amount of hydrocarbons for reuse. At present, there are financial losses from unrecovered crude oil, which is destroyed by thermal desorption (approximately 100% of the material is destroyed).

Moreover, in the cleaning methods and cleaning systems known so far, there is a high poisoning risk due to the presence of gases, as the operator must get into the same tank; moreover, there are explosion risks of due to the type of equipment and tools used.

Thus, the need for automated systems arises, which allow the recovery of larger percentages of hydrocarbons contained in the tank sediments.

### SUMMARY OF THE INVENTION

It is therefore an object of the present invention to provide an automated-modular cleaning system of hydrocarbon storage tanks, which can be installed in any type of area. In an additional embodiment, the system can be a semi-automated-modular system

Moreover, the present invention provides a system that allows more than 80% cleaning time reduction, compared with state-of-the-art systems.

Another object of the present invention is providing a cleaning process comprising the use of chemical mixtures, which act as cleaning and recovery products, respectively.

Another object of the present invention is providing a cleaning process carried out with the system of the present invention, which allows obtaining up to 90% recovery of the hydrocarbons present in the waste.

The above, measured through, for example:

### Characteristics of the Waste

### Water <1%

Solid waste <1%

### ° API=13.0

Oils and paraffins: 30%

Another object of invention is providing a process and a system that allows cleaning of hydrocarbon storage tanks and their recovery for reuse, thus complying with national and international guidelines of environmental care.

An additional object of invention is reducing the final solids disposal in order to protect the environment from being disposed in confinement and be destroyed.

### BRIEF DESCRIPTION OF THE FIGURES

FIG. 1 is a diagram wherein the installation and distribution of the system of the present invention is shown, according to a preferred embodiment.

FIG. 2 is a diagram of the process steps and the distribution of the cleaning system for hydrocarbon storage tanks in accordance with a preferred embodiment of the present invention.

### DETAILED DESCRIPTION OF THE INVENTION

Some aspects of the present invention will now be described in detail using further reference to the attached drawings, wherein the advantages of the present invention are shown (but not limited to). In fact, several embodiments of the invention may be expressed in many different ways and should not be construed as limitations to the embodiments described herein; these exemplary embodiments are provided so that this invention will be exhaustive and complete, and will fully convey the scope of the invention to the person skilled in the art. For example, unless otherwise indicated, something described as first, second or similar should not be interpreted as a particular order. As used in the description and further in the accompanying claims, the singular forms “a”, “an”, “the”, include plural references unless the context clearly Indicates otherwise.

The different aspects of the present invention relate to a system and process for cleaning hydrocarbon storage tanks.

In a first aspect, the present invention discloses a mobile and modular automated cleaning system that allows cleaning hydrocarbon storage tanks without needing personnel entry. Moreover, the present invention system is versatile and can be adapted to different types of tanks according to their type and location. In an additional embodiment, the present invention system can also be a semi-automated system.

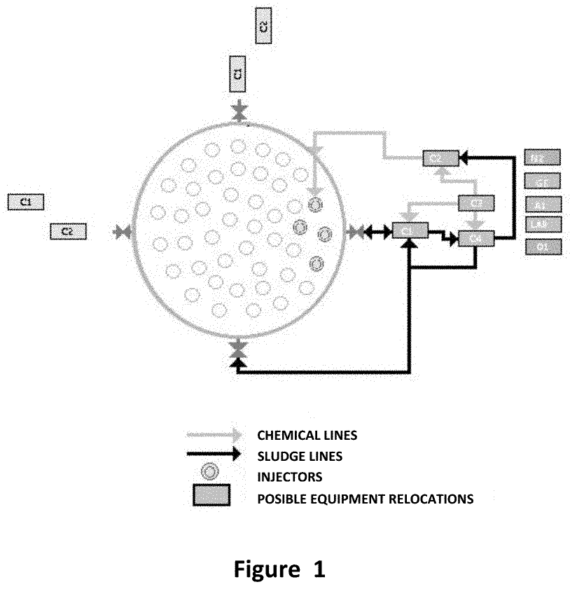

In a preferred embodiment, FIG. 1 shows the system of the present invention (1) and its distribution which comprises one or more tank cleaning injectors (2) of single or multiple nozzles carrying out unique separate turning and lifting movements, allowing a quick self-programmable over-ride for sectorial cleaning. In another aspect, the injector nozzle has a cleaning range from 0 to 180°, while the injector is capable of rotating 360°, covering the entire area to be cleaned and reducing washing times. Moreover, the personnel entry into the confined spaces for cleaning is prevented.

In another aspect, the injectors (2) are programmable according to the cleaning type, either during or before this step.

In another aspect the system (1) comprises an injection and recirculation equipment (C2) mounted on transportable skids, in order to supply the required pressure and flow to the cleaning injector(s) (2). Flow control is achieved by means of a valve included in a suction pump, not shown.

The injection and recirculation equipment (C2) carry out the injection of chemical mixtures through an injection pump or compressor (A1) on the vacuum side of primary pumps. The entire slip is protected against pressure using a safety relief valve on the discharge.

In a relevant aspect of the present invention, the system also comprises an oil waste separation and recovery equipment (not shown), which is operated with at least 50 hp power and at least 3,300 g capacity. In a preferred embodiment the separation and recovery equipment have a process capacity of approximately 10 to 20 m³/h.

In a preferred aspect, the oil waste separation and recovery equipment centrifuges sludge coming from the storage tanks, reducing in the order of micrometers (according to density/solids/gpm/ROP). The solids being separated by such equipment have a range of at least 3″ and reach a discharge of at least 1000 m of horizontal length, depending on the material obtained.

In a further aspect, the system (1) includes an extraction module (C1) to achieve recirculation at the bottom of the reservoir tanks and therefore dilute all types of paraffins or other undesirable compounds.

In a preferred embodiment, the system (1) of the present invention can comprise a chemical mixing tank (C3) and a sludge receiving tank (C4), which may also comprise a single tank (C3/C4) of different capacities according to the cleaning requirements.

In an additional aspect, the system (1) also includes an inert gas generating equipment (N2), preferably nitrogen (N2), the equipment (N2) conducts gas injection on a continuous basis. This injection is made in order to reduce the oxygen concentration below to at least 6%.

The equipment (N2) maintains a constant flow of at least 500 m³/h and up to 300-psi pressure.

Upon being modular, the system (1) can be programmed by the operators themselves. This allows monitoring the needs in the area, such as cases where it is required to inject more pressure, flow or chemical in order to reach the parameters described above. Furthermore, the present invention provides the possibility of installing a mobile laboratory (LAB) and having an electric generator (GE) ready to maintain the correct operation of the entire system.

In another aspect of the present invention, chemical mixtures (Q1) are used which respectively allow recovery and cleaning, and which are applicable to the system (1) of the present invention.

In one embodiment, the cleaning mixture may comprise an oil-soluble asphalt and paraffin dispersant concentrate, which disperses, breaks the molecular chains and wets the solids contained in the tank beds to facilitate the extraction of paraffin and fuel oil residues.

In a preferred embodiment the cleaning mixture may comprise a mixture of benzene derivatives, more particularly it may comprise a mixture of xylenes.

The following table shows a preferred embodiment of the cleaning mixture composition of the present invention:

| Component | % (V/V) |
|---|---|
| Xylene-mixture | 30-70 |
| Fraction C₆—C₁₀ | 30-50 |

In another aspect of the present invention, the recovery mixture comprises a concentrate for quick and safe heavy and viscous sludge treatment in tank beds. Said recovery mixture reaches about 89% to about 99% of the oil contained in the sludge/sediment contained in the tank. Furthermore, the mixture preferably comprises a chemical substance that works dividing the emulsions into three oil fractions, water and solids without using a heat treatment which is usually expensive and dangerous.

In one embodiment, the recovery mixture may comprise benzene derivatives and other organic compounds.

In a preferred embodiment, the recovery mixture may comprise xylenes and fatty acid esters.

The following table shows a preferred embodiment of the recovery mixture composition of the present invention:

| Component | % (V/V) |
|---|---|
| Xylene-mixture | 30-60 |
| Fraction C₆—C₁₀ | 30-50 |
| Epoxidized fatty acid esters | 2-10 |

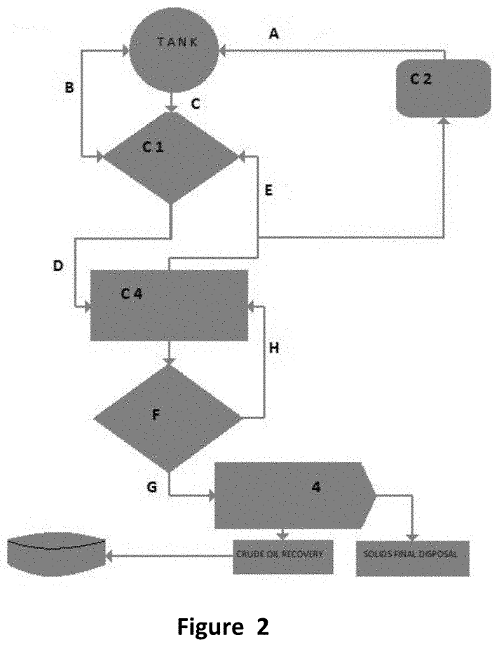

In another aspect of the present invention, a cleaning process of hydrocarbon storage tanks is provided which is described by the diagram in FIG. 2.

In this sense, the chemical mixtures of the present invention (cleaning and recovery) are injected (A) into a hydrocarbon storage tank by the injection equipment and recirculation equipment (C2). At the same time, recirculation (B) is achieved, preferably through the lower part of the tank, and the suction of the oil drains; as well as the extraction (C) of sludge by the extraction module (5) allowing pulverizing any agglomerated product causing its dilution. As the process continues, a sludge receiver/chemical mixer tank (C3/C4) is fed (D) in which different chemical substances are mixed and returned (E) to the extraction module (C1) for the recirculation/release of the oil drains.

In one aspect of the process, the hydrocarbon storage tank is inert when the sludge begins to descend, and a space is created between the dome and the sludge bed contained in the tank.

The purpose of injecting an inert gas into the tank is to displace any oxygen that might enter the space generated between the sludge bed and the dome. The injection of the inert gas will depend on the required demand by the operation.

Prior to the injection of nitrogen, the surface sealing of the tank perimeter and the dome supports is conducted in order to minimize the oxygen entry and the inert gas leakage to be injected.

In a preferred embodiment, the flow of the inert gas to be injected will have a variant range between 150 and 350 m³/h depending on the operation.

In a next step, sampling (F) of the obtained products is achieved. If conditions (G) are met, the products are sent to the separation and recovery equipment (not shown) to obtain crude and different solids. Otherwise, the products are returned (H) to the tank (C3/C4). Finally, the recovered products are returned to a container for reuse/commercialize. Moreover, when the dilution and extraction of the sludge from the interior of the hydrocarbon storage tank is completed, the injectors are relocated to cover a larger part of the tank at the actuation stage. It begins with the water recirculation through the injection and recirculation equipment (C2) which will be programmed to impact the walls, bottom and dome of the tank.

In an additional embodiment, the process may include manual hydrocarbon storage tank cleaning by removing all perimeter seals and the hydrocarbon storage tank supports seals, a venting system (Venturi) may be placed to vent all possible generated gases during the process.

A visual inspection of the interior of the tank will be made after the tank is vented. Small solids portions that are trapped in the tank structures will be manually removed by means of the extraction module (C1) whose waste will be ejected into a gondola for transport and final disposal.

### EXAMPLES

The examples described in detail hereinafter, with respect to the subject matter of the present invention, do not limit the scope of the present application in any way.

### Example 1

### Technical Proposal for Cleaning the Tv-5002 Tank of 500,000 Bls Located in Dos Bocas Maritime Terminal

Prior to the cleaning system installation, the sludge was measured to identify which quadrant and vacuum point is suitable to start the process.

During the cleaning system location, ashtray type mats were installed to protect the floor in case of any spillage.

The process begins making a vacuum in the oil drainage of Ø4″, the sludge extraction module creates a vacuum of 25′ Hg with a discharge of 7 bar which allows pulverizing all agglomerated product causing its dispersion, then the chemical mixtures injection will be made from the bottom (oil drains) and by the injectors in order to dissolve the sludge located in the first quadrant of the tank. This breaks the van der Waals bonds of the molecular chains of the fuel oils and paraffins returning them to their liquid state.

The chemical mixtures injection and the recirculated sludge injection into the dome of the tank is achieved by the injectors suitable for working in explosive zones, which have the capacity to reach a shot up to a radius between 25 and 30 m with a sludge breaking efficiency of 70 cm due to their design and according to the operating conditions required in the area.

The injectors design allows to be installed on the supports (legs) of the tank dome, achieving different strategies for their location and better performance during the process.

The injection and recirculation system are responsible for recirculating the sludge and chemicals with a flow rate between 80 and 110 m³/h at an 8 and 15 bar pressure.

During the cleaning process, two 70 m³ containers were used to store and mix the settled sludge and chemical mixtures. These containers served to maintain a constant and efficient recirculation process.

The process area was delimited and monitored by security personnel to ensure the safety of the operating personnel.

During the sludge and chemical mixtures extraction, and the dilution and recirculation process, the recirculated product is sampled to analyze the chemical saturation proceeding with their recovery from the hydrocarbons and conduct to a physical separation, if necessary.

During the diluted sludge recirculation process, BS&W tests were performed to determine the solids, water and oil quantity contained in the diluted sludge batch.

The mechanical separation was fulfilled with the separation and recovery equipment, by means of the horizontal centrifuge mounted on a stand that has a separation performance between 10 and 20 m³ at about 3000 rpm, depending on the operating conditions.

The separated solid fraction of the mixture contained in the sludge was placed in gondolas for transport and final disposal having the necessary permits for such activities.

The liquid fraction (recovered crude) was delivered to PEMEX with prior authorization from DIAVAZ to verify the quality of the product.

Tank inerting was achieved with the nitrogen generation equipment.

This tank inerting step takes place when the sludge begins descending and a space is generated between the dome and the sludge bed contained in the tank.

The purpose of injecting an inert gas into the tank is to displace any oxygen that might enter the space generated between the sludge bed and the dome.

The inert gas injection will depend on the demand required by the operation.

Prior to the nitrogen injection, the tank perimeter and the dome supports were superficially sealed to minimize the oxygen input and the inert gas leakage to be injected.

The inert gas flow to be injected varies between 150 and 350 m³/h depending on the operation.

When the sludge dilution and removal from the interior of the tank is completed, the injectors were relocated to cover a large part of the tank at the actuation stage.

Then, water recirculation was initiated by injectors means which were programmed to impact the walls, bottom and dome of the tank.

Finally, the small portions of solids trapped in the tank structures were manually removed by means of the Solids Extraction CIP which has a vacuum capacity up to 50 m and were ejected into the gondolas for transport and final disposal.

Many modifications and other embodiments of the invention will come to mind of those skilled in the art to which this invention pertains, who has the benefit of teachings presented in the previous description and attached drawings. Therefore, the invention should not be limited to the specific disclosed embodiments, but that the modifications and other embodiments are intended to be included within the scope of the enclosed claims. Although the specific terms are used here, they are used only in a generic and descriptive sense and not for limiting purposes.

1. A cleaning system for hydrocarbon storage tanks, characterized in that it is an automated and modular system comprising:
one or more programmable cleaning injectors carrying out unique, separate turning and lifting movements;
an injection and recirculation equipment that injects chemical mixtures through an injection pump or compressor located at the vacuum end of primary pumps;
an oil waste separation and recovery equipment;
an extraction module; and
an inert gas generation and injection equipment.

2. The system according to claim 1, wherein the injectors have one or more nozzles with a cleaning range from 0 to 180°, and the injectors rotate 360°.

3. The system according to claim 1, wherein the injection and recirculation equipment is mounted on transportable skids.

4. The system according to claim 3, wherein the injection and recirculation equipment provides pressure and required flow to the cleaning injectors.

5. The system according to claim 4, wherein the required flow is achieved by a valve included in a vacuum pump.

6. The system according to claim 1, wherein the oil waste separation and recovery equipment has at least 50 hp power and at least 10 to 20 m³/h process capacity.

7. The system according to claim 6, wherein the oil waste separation and recovery equipment performs the sludge centrifugation from the hydrocarbon storage tank, reducing in order of micrometers.

8. The system according to claim 1, wherein the extraction module performs a recirculation at the bottom of the storage tank to dilute all types of paraffins or other undesirable compounds.

9. The system according to claim 1, wherein the inert gas generation and injection equipment has a constant flow of at least 500 m³/h and up to 300 psi pressure.

10. The system according to claim 1, wherein the inert gas is preferably nitrogen.

11. The system according to claim 1, wherein said system may additionally separately comprise a chemical mixing tank and a sludge receiving tank, or a single tank for both purposes.

12. The system according to claim 1, wherein said system may additionally comprise a mobile laboratory and an electric generator.

13. Chemical mixtures used in the system according to claim 1, wherein said mixtures comprise a cleaning mixture and a recovery mixture.

14. Chemical mixtures according to claim 13, wherein the cleaning and recovery mixture comprises a mixture of benzene derivatives, such as xylenes.

15. Chemical mixtures according to claim 14, wherein the cleaning mixture comprises in v/v 30 to 70% of xylenes and 30 to 50% of C₆-C₁₀ hydrocarbons.

16. Chemical mixtures according to claim 14, where the recovery mixture comprises in v/v 30 to 60% of xylenes, 30 to 50% of C₆-C₁₀ hydrocarbons and 2 to 10% of epoxidized fatty acid esters.

17. A cleaning process for hydrocarbon storage tanks by the system of claim 1, characterized in that comprises:
chemical mixtures are injected into a hydrocarbon storage tank by injection means and recirculation equipment;
simultaneously, recirculation is performed, preferably in the lower part of the tank, and the oil drains vacuum; as well as the extraction of sludge by means of the extraction module, which allows any agglomerated product to be pulverized, causing it to be diluted;
as the process continues, a sludge receiving tank/chemical mixer is fed wherein different chemicals are mixed and returned to the extraction module for the oil drains recirculation/release;
the hydrocarbon storage tank is inerted when the sludge begins descending and a space is created between the dome and the sludge bed contained in the tank; and
sampling the obtained products, if conditions are met, the products are sent to the separation and recovery equipment obtaining raw and different solids; otherwise, the products are returned to the tank.
